(19) United States
(12) Patent Application Publication
(10) Pub. No.: US 2007/0042198 A1
(43) Pub. Date: Feb. 22, 2007

(54) Antimicrobial substrate, a method and a composition for producing it

(76) Inventors: Lars Schonemyr, Goteborg (SE); Ann-Cathrin Olofsson, Goteborg (SE); Daniel Persson, Goteborg (SE)

Correspondence Address: HARNESS, DICKEY & PIERCE, P.L.C., P.O. BOX 8910, RESTON, VA, 20195, US

(21) Appl. No.: 10/551,776

(22) PCT Filed: Apr. 2, 2004
(86) PCT No.: PCT/SE04/00519

§ 371 Date: Sep. 29, 2006

(30) Foreign Application Priority Data
Apr. 4, 2003 (SE) 0301019-6
May 14, 2003 (SE) 0301408-1
Jan. 9, 2004 (SE) 0400038-6
Jan. 14, 2004 (SE) 0400073-3

(51) Int. Cl. B32B 27/00

(52) U.S. Cl. 428/447; 428/500

(57) ABSTRACT

An antimicrobial substrate is disclosed, having adhered to at least a part of its surface an organosilicon quaternary ammonium salt compound, such as 3-(trimethoxysilyl)propyl-dimethyloctadecyl ammonium chloride for example, and having a cationic, preferably hydrophilic, polymer, such as a polyethylene imine or polyhexamethylene biguanide hydrochloride. A method is further disclosed for producing the substrate, as well as a composition for use in the production of the substrate.

### TECHNICAL FIELD

The present invention generally relates to the field of antimicrobials. More specifically, the present invention relates to an antimicrobial substrate having adhered to at least a part of its surface an organosilicon quaternary ammonium salt compound, a method for producing said substrate and a composition for use in the production of said substrate.

### TECHNICAL BACKGROUND

An antimicrobial is an agent that prevents microbiological contamination by destroying (killing), inhibiting the growth or reproduction of, and/or removing microorganisms, such as bacteria, fungi, yeasts, algae, and virus.

One of the most common classes of antimicrobials is quaternary ammonium salts (QAS), such as dodecyltrimethyl ammonium bromide (DTAB).

A sub-class of QAS is organosilicon quaternary ammonium salt compounds (also referred to as quaternized organosilanes). These compounds and different uses thereof are well known within the field. Examples of some prior art references describing antimicrobial uses of quaternized organosilanes are U.S. Pat. Nos. 3,560,385; 3,730,701; 3,794,736; 3,814,739; U.S. Pat. Nos. 3,730,701; 3,794,736; 3,817,739; 3,860,709; 3,865,728; 4,282,366; 4,504,541; 4,564,456; 4,615,937; 4,692,374, 4,408,996; 4,414,268; 4,425,372; 4,395,454; 4,411,928; 4,822,667; and 4,835,019.

Organosilicon quaternary ammonium salt compounds are bacteriostatic/bactericidal, fungistatic/fungicidal, sporostatic, algistatic/algicidal, and viricidal.

Most cells have a net negative charge and are thus attracted to positively charged organosilicon quaternary ammonium salt compounds.

3-(trimethoxysilyl)propyl-dimethyloctadecyl ammonium chloride (Formula I), also called TMS (sold by Aegis Enviromental Management Inc under the trademark AEM 5772/5, previously Dow Corning 5700, CAS No 27668-52-6) is an example of a commercially commonly used quaternized organosilane. TMS may be prepared by quaternization of dimethyloctadecylamine with 3-chloropropyltrimethoxysilane.

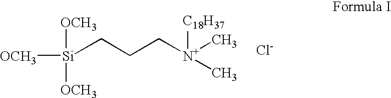

In aqueous media, it is believed that TMS is converted to 3-(trihydroxysilyl)propyl-dimethyloctadecyl ammonium chloride. This compound is capable of binding to a wide variety of natural and synthetic substrate surfaces, such as wood; metal; glass; leather; plastics, e.g. polyethylene and polypropylene; rubber; ceramics; paper and fabrics, e.g. cellulose, cotton, polyamides, and polyesters. Therefore, a common method of adhering it to a substrate surface is to add a dilute solution of TMS in methanol to water and then treat the substrate with the thus obtained solution to provide an antimicrobial coating.

3-(trihydroxysilyl)propyl-dimethyloctadecyl ammonium chloride binds to the surface either through (i) ionic bonds between O⁻on a negatively charged surface possessing acidic hydroxyl groups and the positively charged ammonium ion, through (ii) covalent bonds between OH on a surface possessing non-acidic hydroxyl groups and the —Si—OH group, or through (iii) electrostatic attraction between the negative charge that exist on most non-hydroxylated surfaces and the positively charged ammonium ion. It is also believed that intermolecular siloxane polymerisation (—Si—O—Si— bonds) occurs on the surface between the surface-associated molecules.

The C₁₈ hydrocarbon chain quaternary ammonium portion of TMS is believed to provide the antimicrobial properties of the compound.

The killing of microorganisms by the action of a quaternized organosilane, such as TMS, is however believed to be a rather slow process. If a lot of microorganisms are adsorbed by a substrate surface, such as a cleansing cloth, modified with an antimicrobial quaternized organosilane, the microorganisms are believed to become rather loosely attached to the substrate surface and as a consequence alive, i.e. not yet killed, microorganisms may leak from the substrate surface.

It would be a great advantage if this problem could be avoided.

Furthermore, the surface of a material coated with a quaternized organosilane is rather hydrophobic thus giving the material a rather poor absorption capacity of hydrophilic liquids, such as blood and water. A poor absorption capacity of hydrophilic liquids may be a disadvantage in certain applications, such as cleansing mops and cloths. High hydrophobicity is also a disadvantage in those applications where the antimicrobial material is to be washed and re-used, such as clothing and articles of beddings. Another application wherein a high hydrophobicity is a disadvantage is a water filter. However, when increasing the hydrophilicity of an antimicrobial material, it is also of great importance not to impair the antimicrobial activity of the material.

### SUMMARY OF INVENTION

An object of the invention is to provide an antimicrobial substrate having adhered to at least a part of its surface an organosilicon quaternary ammonium salt compound, said substrate having an improved adhesion of microorganisms, preferably an increased surface charge density and thus the ability to more strongly adsorb microorganisms, or even the ability to adsorb more microorganisms per surface area of the substrate.

It is also preferred that said surface charge density is preserved during washing of the substrate.

Another object of the invention is to provide an antimicrobial substrate having adhered to at least a part of its surface an organosilicon quaternary ammonium salt compound, said substrate having an increased hydrophilicity but preserved antimicrobial activity.

A substrate having a surface modified according to the present invention may be used in several different applications.

According to a first aspect of the invention, there is provided an antimicrobial substrate having adhered to at least a part of its surface an organosilicon quaternary ammonium salt compound and a cationic polymer.

Said cationic polymer is preferably hydrophilic.

The cationic polymer is preferably a polyethylene imine or polyhexamethylene biguanide hydrochloride (PHMB). Both these polymers comprise —NH— in the polymeric backbone.

Said organosilicon quaternary ammonium salt compound is preferably 3-(trimethoxysilyl)propyl-dimethyloctadecyl ammonium chloride.

According to a second aspect of the invention, there is provided a method for producing an antimicrobial substrate, as described above, comprising adhering an organosilicon quaternary ammonium salt compound to at least a part of the substrate surface, and adhering a cationic polymer to at least a part of the substrate surface.

Said cationic polymer is preferably hydrophilic.

The cationic polymer is preferably a polyethylene imine or polyhexamethylene biguanide hydrochloride (PHMB).

Said organosilicon quaternary ammonium salt compound is preferably 3-(trimethoxysilyl)propyl-dimethyloctadecyl ammonium chloride.

According to a third aspect of the invention, there is provided a composition for use in the production of an antimicrobial substrate, as described above, said composition comprising an organosilicon quaternary ammonium salt compound and a cationic polymer.

Other features and advantages of the present invention will become apparent from the following description of the invention.

### DETAILED DESCRIPTION OF THE INVENTION

The invention relates to an antimicrobial substrate having adhered to at least a part of its surface an organosilicon quaternary ammonium salt compound and a cationic polymer, preferably hydrophilic.

Most microbial cells are negatively charged and hydrophobic. Thus, most microorganisms are attracted to positively charged, hydrophobic surfaces. Without being bound by any theory, it is believed that the cationic polymer adhered to the substrate surface according to the invention provides an increased (compared to a substrate surface having a quaternized organosilane but no cationic polymer adhered thereto) positive surface charge density on the substrate surface. The increased positive surface charge density in turn provides an increased electric field strength in a specific medium, such as air.

The increased positive surface charge density results in an increased microorganism adhesion, thus preventing leakage of alive microorganisms from the substrate surface. In some applications, even more microorganisms per surface area may be adhered to the substrate.

The cationic polymer adhered to at least a part of the substrate surface is preferably hydrophilic, thus providing an increased (compared to a substrate surface having a quaternized organosilane but no cationic, hydrophilic polymer adhered thereto) hydrophilicity but preserved antimicrobial activity.

Examples of cationic polymers for use according to the invention are polyethylene imines, polyhexamethylene biguanide hydrochloride (PHMB), cationic starch, polyDAD-MAC (polydimethyldiallyl ammonium chloride), polyaluminium chloride, cationic polyamides, cationic polyamines, such as polyamine-epichlorohydrin resins, and cationic derivatives of polyacrylamides. Other cationic polymers, which may be used according to the invention, are also known to persons skilled in the art.

It shall be noted that PHMB itself has been classified as an antibacterial compound.

PHMB comprises an average of 12 biguanides per molecule.

Polymers with a small number of repeating units, such as 2-20 units, are often referred to as oligomers. Thus, PHMB may be referred to as an oligomer or a short polymer.

The cationic polymer may be a branched or linear polymer, but is preferably a branched polymer. A branched polymer may be physically and/or mechanically attached to the substrate surface by entanglement of its polymer chain in the organosilane network on the substrate surface, formed as described in the Technical Background.

It shall be noted that the cationic polymer also may be chemically attached, such as by covalent bonds, to the substrate surface.

The cationic polymer is preferably polyethylene imine or PHMB. Both these polymers comprise —NH— in the polymeric backbone.

Said polyethylene imine is preferably a branched polyethylene imine.

Moreover, said polyethylene imine preferably has an average molecular weight within the range of 800 to 750 000.

Suitable antimicrobial organosilicon quaternary ammonium salt compounds for use according to the invention are represented by Formula II: 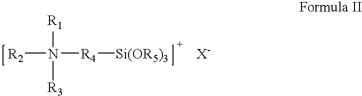
wherein

R₁ is an C₁₋₃₀ alkyl group, preferably C₈₋₃₀ alkyl group,

R₂ and R₃, R₄ and R₅ each independently are an C₁₋₃₀ alkyl group or hydrogen, and

X is a counter ion, such as Cl⁻, Br⁻, I⁻ or CH₃COO⁻.

Examples of organosilicon quaternary ammonium salt compounds for use according to the invention are 3-(triethoxysilyl)-propyl-dimethyloctadecyl ammonium chloride, 3-(tri-methoxysilyl)propyl-methyl-dioctyl ammonium chloride, 3-(trimethoxysilyl)propyl-dimethyldecyl ammonium chloride, 3-(trimethoxysilyl)-propyl-methyldidecyl ammonium chloride, 3-(trimethoxy-silyl)propyl-dimethyldodecyl ammonium chloride, 3-(tri-methoxysilyl)-propyl-methyldidodecyl ammonium chloride, 3-(trimethoxy-silyl)propyl-dimethyltetradecyl ammonium chloride, 3-(trimethoxy-silyl)propyl-methyldihexadecyl ammonium chloride, and 3-(trimethoxysilyl)propyl-dimethyloctadecyl ammonium chloride.

More preferably, the organosilicon quaternary ammonium salt compound is a 3-(trimethoxysilyl)propyl-dimethyloctadecyl ammonium halide, most preferably 3-(trimethoxy-silyl)propyl-dimethyloctadecyl ammonium chloride (R₁═—C₁₈H₃₇, R₂═—CH₃, R₃═—CH₃, R₄═—C₃H₆—, R₅═—CH₃, and X═Cl⁻).

The substrate according to the invention may comprise 3-8% (w/w) TMS, on dry weight basis.

An exemplary embodiment of the substrate according to the invention comprises TMS and a polyethylene imine in a weight ratio of 1:1.

Another exemplary embodiment of the substrate according to the invention comprises TMS and a polyethylene imine in a weight ratio of 40:1.

Thus, the ratio between TMS and PEI may be within the range of from 1:1 to 40:1, but the desired effect according to the invention may also be obtained outside this range.

Still another exemplary embodiment of the substrate according to the invention comprises TMS and PHMB in a weight ratio of 1:1.

The substrate according to the invention adsorbs, and/or absorbs, and retains microbes, such as bacteria, fungi and/or virus.

The substrate according to the invention can thus be used for removing microorganisms from surfaces, such as biological surfaces, including skin and wounds, construction surfaces, including building surfaces, furniture surfaces and automative surfaces, air and water.

Examples of microbes being adsorbed/absorbed and retained by the substrate according to the invention are Staphylococcus strains, such as Staphylococcus aureus, Streptococcus strains, Fusarium strains, Salmonela strains, Shigella strains, Yersinia strains, Escheria coli, Bacillus cereus, calivirus, Norwalk virus and similar virus, Campylobacteria, Clostridium botulinum, C. perfringes, Listeria monocytogenes, Penicillium, and Aspergillus.

The surface of the substrate (or the entire substrate), according to the invention, to which the organosilicon quaternary ammonium salt compound and the cationic polymer are adhered may be of wood; metal; glass; leather; plastics, such as polyethylene and polypropylene; rubber; ceramics; paper; non-woven or woven fabrics of inorganic or organic fibers, such as naturally occurring fibers, polymeric fibers, composite fibers, etc. For instance, fibers of cellulose, cotton, wool, glass, stone, calcium sulphate, carbon, polyamides, polyolefins, and polyesters may be used for preparing non-woven or woven fabrics.

For material surfaces lacking hydroxyl functionality (i.e. lacking —OH groups), such as polyethylene and polypropylene, it may be advantageous to hydrolyze the surface before applying the organosilicon quaternary ammonium compound. Hydrolyzing may, for instance, be performed by contacting the surface with an aqueous acid, such as sulphuric acid, an alkaline hydroxide, such as sodium hydroxide or hydrogen peroxide.

Examples of applications (substrate) include sanitary equipment, such as a surface cleansing cloth for hard or semi-hard surfaces (e.g. furniture, walls, floors, etc) or a mop textile; water and air filters, such as for use in breathing masks and in venting systems in prenatal incubators, buildings or vehicles; liquid absorbing material in food packages; clothing, including training clothes, such as intimate apparel, stockings and socks; protective clothing, including different working clothes, such as cooking, laboratory and medical/surgical clothes; shoes, including shoe soles; sanitary articles, such as sanitary napkins, panty liners, diapers, and incontinence guards; refreshers/wet wipes; napkins; handkerchiefs; paper and textile towels; wound compresses/cloths (for instance, for treatment of eczema and burn injuries); adhesive dressings; plaster; medical/surgical cloths/clothing, gloves, face masks and coverings, including pre-surgery coverings and paper and plastic film coverings for medical examination tables; plastic film for use in a laboratory; agricultural plastic film for storage of hay; coverings in general; articles of beddings, such as sheets, quilts, blankets, quilt covers, mattress covers, pillows, and pillow cases; fibrous, plastic and rubber gloves, including disposable gloves, such as latex and PVC ; containers, wrappings, and bags/sacks, including food packaging (e.g. plastic film) and storage of other objects, such as sand and dirty washing.

An embodiment of the substrate according to the invention is a substrate, such as a refresher, in the form of a layered structure comprising a first layer having adhered to at least part of its surface an organosilicon quaternary ammonium salt compound and a cationic, preferably hydrophilic, polymer, and a second layer having a surface comprising one or more skin treating agent.

The surface of the second layer is preferably arranged on a side of the substrate being opposite to the side of the substrate on which the surface of the first layer is arranged.

Examples of skin treating agents are wound-cleansing preparations, such as a saline solution; wound-healing preparations, such as an ointment, a viscous liquid or gel, possibly containing nourishing substances and/or growth factors; and other skin lotions, creams and ointments, such as a moisture lotion, a sunscreen lotion, or a suntan lotion.

The invention also relates to a method for producing the above described antimicrobial substrate, said method comprising adhering an organosilicon quaternary ammonium salt compound to at least a part of the substrate surface, and adhering a cationic, preferably hydrophilic, polymer to at least a part of the substrate surface.

The organosilicon quaternary ammonium salt compound may be applied before, after or simultaneously with the cationic polymer.

The organosilicon quaternary ammonium salt compound and the cationic polymer may be comprised in the same aqueous composition, and thus applied on the substrate surface in a single step.

Preferably, the organosilicon quaternary ammonium salt compound and the cationic polymer are applied simultaneously on the substrate surface using a single aqueous composition comprising both compounds.

Hence, the invention also relates to a composition, preferably an aqueous composition, comprising an organosilicon quaternary ammonium salt compound and a cationic polymer.

The organosilicon quaternary ammonium salt compound, is preferably a compound according to Formula II and may be any one of the compounds exemplified above.

The organosilicon quaternary ammonium salt compound in the composition according to the invention is preferably TMS.

The cationic polymer in the composition according to the invention may be any one of the polymers exemplified above, but is preferably polyethylene imine or PHMB. Both these polymers comprise —NH— in the polymeric backbone.

Said polyethylene imine is preferably a branched polyethylene imine.

Moreover, said polyethylene imine preferably has an average molecular weight within the range of 800 to 750 000.

An exemplary embodiment of the composition according to the invention comprises TMS and a polyethylene imine in a weight ratio of 1:1.

Another exemplary embodiment of the composition according invention comprises TMS and PHMB in a weight ratio of 1:1.

Another exemplary embodiment of the composition according to the invention comprises TMS and a polyethylene imine in a weight ratio of 40:1.

Thus, the ratio between TMS and PEI in the composition according to the invention may be within the range of from 1:1 to 40:1, but the desired effect according to the invention may also be obtained outside this range.

The invention will now be illustrated by means of the following non-limiting examples.

### EXAMPLE 1

### Production of Modified Cloths

0.5 1 of an aqueous solution of 3-(trimethoxy-silyl)propyl-dimethyloctadecyl ammonium chloride (TMS), 0.5% by weight, and a branched polyethylene imine (PEI) (CAS No 25987-06-8), 0.5% by weight was prepared by adding TMS and PEI to water and stirring for 15 minutes at room temperature.

An alkali washed cloth of polyester (80%) and polyamide (20%), 10 g, was immersed during stirring for 30 min in the TMS:PEI solution, squeezed and heated at 150° C. for 15 minutes.

### EXAMPLE 2

### Evaluation of Bacteria Adsorption

Alkali washed cloths of polyester (80%) and polyamide (20%) were treated according to the procedure described in Example 1 using polyethylene imines of different molecular weights (800, 2 000, 25 000, 50 000, and 750 000). The polyethylene imine of molecular weight 50 000 was ethoxylated.

In addition, a similar cloth was treated according to the procedure described in Example 1 except that polyethylene imine was replaced by polyhexamethylene biguanide hydrochloride (PHMB).

An untreated similar cloth, a similar cloth treated with an aqueous solution containing merely TMS (0.5%), and a similar cloth treated with an aqueous solution containing merely polyethylene imine having a molecular weight of 800 (0.5%) were used as comparative samples.

Bacteria adsorption to the above cloths (except the cloth treated with merely polyethylene imine) were evaluated using strains of Staphylococcus aureus (Gram positive) and Escherichia coli (Gram negative). Each bacteria strain were suspended in a saline solution (0.9% NaCl) and the optical density (OD) of the suspensions at 420 nm were measured. The suspensions were found to contain about 2.3×10⁹ S. aureus/ml and about 1.1×10⁸ E. coli/ml, respectively.

A small piece (1 g) of each cloth was incubated in 30 ml of each bacteria suspension for 30 minutes, whereupon the cloths were removed from the suspensions and the optical density of each suspension measured. The results are presented in Table 1 and Table 2.

TABLE 1
Escherichia coli

| | | OD after 30 | |
|---|---|---|---|
| | Initial OD | minutes | Δ |
| Treatment | | | |
| TMS + PEI | 0.184 | 0.029 | 0.155 |
| (800) | | | |
| TMS + PEI | 0.179 | 0.058 | 0.121 |
| (2 000) | | | |
| TMS + PEI | 0.178 | 0.033 | 0.145 |
| (25 000) | | | |
| TMS + PEI | 0.177 | 0.039 | 0.138 |
| (50 000) | | | |
| TMS + PEI | 0.184 | 0.020 | 0.164 |
| (750 000) | | | |
| TMS + PHMB | 0.183 | 0.051 | 0.132 |
| Comparative | | | |
| samples | | | |
| untreated | 0.178 | 0.176 | 0.002 |
| TMS | 0.178 | 0.107 | 0.071 |

TABLE 2
Staphylococcus aureus

| | | OD after 30 | |
|---|---|---|---|
| | Initial OD | minutes | Δ |
| Treatment | | | |
| TMS + PEI | 0.179 | 0.029 | 0.150 |
| (800) | | | |
| TMS + PEI | 0.178 | 0.037 | 0.141 |
| (2 000) | | | |
| TMS + PEI | 0.176 | 0.054 | 0.122 |
| (25 000) | | | |
| TMS + PEI | 0.177 | 0.037 | 0.140 |
| (50 000) | | | |
| TMS + PEI | 0.181 | 0.026 | 0.155 |
| (750 000) | | | |
| TMS + PHMB | 0.181 | 0.024 | 0.157 |
| Comparative | | | |
| samples | | | |
| untreated | 0.175 | 0.133 | 0.042 |
| TMS | 0.178 | 0.048 | 0.130 |

As shown by the results presented in Table 1 and 2, more bacteria adhere to the cloths according to the invention than to the cloths used as comparative samples.

### EXAMPLE 3

### Evaluation of Wettability

The relative wettability (˜hydrophilicity) of the cloths used in Example 2 was estimated by applying a drop (100 μl) of an aqueous solution of CuSO₄ (1 M) on each cloth and measuring the time period until the drop was absorbed by the cloth.

The applied water drop was instantaneously absorbed by the untreated cloth and the cloth treated with only PEI (800), respectively.

No absorption was observed for the cloth treated with only TMS.

For the cloths treated with TMS and PEI of different molecular weights, the absorption times were found to be between 10 and 80 minutes.

The cloth treated with TMS and ethoxylated PEI (50 000) showed the shortest absorption time, i.e. the highest wettability.

The other cloths showed wettabilty according to the following (highest wettability to the left):
TMS+PEI(750,000)>TMS+PEI(25,000)>TMS+PEI(800)>TMS+PEI(2,000)

### EXAMPLE 4

### Determination of Surface Charge and Wetting Properties

An alkali washed cloth of polyester (80%) and polyamide (20%) was treated according to the procedure described in Example 1 using a polyethylene imine having a molecular weight of 750 000, with the exception that the concentration of TMS was 1% by weight and the concentration of PEI was 250 ppm.

A similar cloth treated with an aqueous solution containing merely TMS (0.5%) was used as comparative sample.

Surface Charge

The surface charge on each cloth was measured using a static sensor, 3M Static Sensor, model 709. All calibration measurements complied with MIL-STD-45662A.

A mat, connected to ground, was placed on a table. The sensor was kept approximately 10 mm above the mat and put to zero. Each cloth was then placed on the mat and the sensor was placed 10 mm above the cloth surface. The charge was measured at three different locations on each cloth and the measurements were repeated three times. The sensor was re-zeroed against the grounded mat between each set of measurement.

The results from the charge measurements are presented in Table 3.

TABLE 3

| | |
|---|---|
| | Surface charge |
| Surface charge | average |
| (arbitrary units) | (arbitrary units) |

Cloth treated with TMS

| | | |
|---|---|---|
| 1^{st} location | 780, 805, 820 | 802 |
| 2^{nd} location | 927, 825, 900 | 884 |
| 3^{rd} location | 100, 195, 175 | 157 |

Cloth treated with TMS and PEI

| | | |
|---|---|---|
| 1^{st} location | 1480, 1685, 1638 | 1601 |
| 2^{nd} location | 1870, 1930, 1821 | 1874 |
| 3^{rd} location | 1225, 1269, 1311 | 1268 |

As shown in Table 3, the cloth treated with both TMS and PEI has a significantly higher positive surface charge, a surface charge average of 1581, than the cloth treated with merely TMS, a surface charge average of 614.

It was also shown that the charge varies over the cloth surface. The surface charge was, for instance, found to be highest in location 2, i.e. in the centre of the cloth.

Moreover, the surface charge on the cloth treated with merely TMS appears to be more heterogeneous than the cloth treated with both TMS and PEI.

Wetting Properties

The wetting properties of the cloths were determined by measurements in a Dynamic Absorption Tester (DAT), manufactured by Fibro Systems AB. The spreading and penetration of liquid droplets, in this example water, can be followed with a time resolution of about 20 ms. A droplet of the liquid is pumped from a syringe attached to a screw pump and the drop is automatically applied to the surface by a short stroke of an electromagnet. A CCD camera connected to a PC follows the spreading and absorption of the droplet. During the first second, 50 images are captured and stored for later analysis. After the first second, the images are analysed on-line and less images are then captured, 5-10 images/second.

The images were analysed with respect to contact angle.

The results from the water contact angle measurements (average values of 3-5 measurements) are presented in Table 4.

TABLE 4

| | Water contact angle |
|---|---|
| | (degrees) |
| Cloth treated with TMS | 105 |
| Cloth treated with TMS and PEI | 95 |

The results show that the cloth treated with merely TMS are more hydrophobic than the cloth treated with both TMS and PEI.

While the invention has been described in detail and with reference to specific embodiments thereof, it will be apparent for one skilled in the art that various changes and modifications can be made therein without departing from the spirit and scope thereof.

1. An antimicrobial substrate comprising:
an organosilicon quaternary ammonium salt compound adhered to at least a part of a surface of the substrate and
a cationic polymer-adhered to at least a part of the surface.

2. A substrate according to claim 1, wherein the cationic polymer is a hydrophilic polymer.

3. A substrate according to claim 1, wherein the cationic polymer comprises —NH— in the polymeric backbone.

4. A substrate according to claim 3, wherein the cationic polymer is a polyethylene imine.

5. A substrate according to claim 3, wherein the cationic polymer is polyhexamethylene biguanide hydrochloride (PHMB).

6. A substrate according to claim 1, wherein the antimicrobial organosilicon quaternary ammonium salt compound is according to Formula II 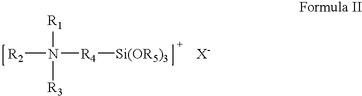
wherein
R₁ is an C₁₋₃₀ alkyl group, preferably an C₈₋₃₀ alkyl group,
R₂ and R₃, R₄ and R₅ each independently are an C₁₋₃₀ alkyl group or hydrogen, and
X is a counter ion, such as Cl⁻, Br⁻, I⁻ or CH₃COO⁻.

7. A substrate according to claim 6, wherein the antimicrobial organosilicon quaternary ammonium salt compound is 3-(trimethoxysilyl)propyl-dimethyloctadecyl ammonium chloride.

8. A method for producing an antimicrobial substrate according to claim 1, comprising:
adhering an organosilicon quaternary ammonium salt compound to at least a part of the substrate surface, and
adhering a cationic polymer to at least a part of the substrate surface.

9. A composition for use in the production of an antimicrobial substrate according to claim 1, comprising an organosilicon quaternary ammonium salt compound and a cationic polymer.

10. A substrate according to claim 2, wherein the cationic polymer comprises —NH— in the polymeric backbone.

11. A substrate according to claim 2, wherein the antimicrobial organosilicon quaternary ammonium salt compound is according to Formula II 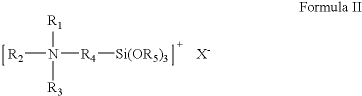
wherein
R₁ is an C₁₋₃₀ alkyl group, preferably an C₈₋₃₀ alkyl group,
R₂ and R₃, R₄ and R₅ each independently are an C₁₋₃₀ alkyl group or hydrogen, and
X is a counter ion, such as Cl⁻, Br⁻, I⁻ or CH₃COO⁻.

12. A substrate according to claim 3, wherein the antimicrobial organosilicon quaternary ammonium salt compound is according to Formula II 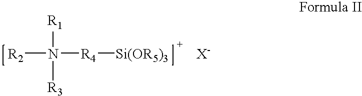
wherein
R₁ is an C₁₋₃₀ alkyl group, preferably an C₈₋₃₀ alkyl group,
R₂ and R₃, R₄ and R₅ each independently are an C₁₋₃₀ alkyl group or hydrogen, and
X is a counter ion, such as Cl⁻, Br⁻, I⁻ or CH₃COO⁻.

13. A substrate according to claim 4, wherein the antimicrobial organosilicon quaternary ammonium salt compound is according to Formula II 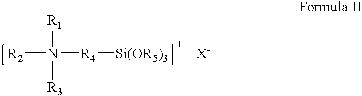
wherein
R₁ is an C₁₋₃₀ alkyl group, preferably an C₈₋₃₀ alkyl group,
R₂ and R₃, R₄ and R₅ each independently are an C₁₋₃₀ alkyl group or hydrogen, and
X is a counter ion, such as Cl⁻, Br⁻, I⁻ or CH₃COO⁻.

14. A composition for use in the production of an antimicrobial substrate according to claim 2, comprising an organosilicon quaternary ammonium salt compound and a cationic polymer.

15. A composition for use in the production of an antimicrobial substrate according to claim 3, comprising an organosilicon quaternary ammonium salt compound and a cationic polymer.

16. A composition for use in the production of an antimicrobial substrate according to claim 4, comprising an organosilicon quaternary ammonium salt compound and a cationic polymer.

17. A method for producing an antimicrobial substrate, comprising:
adhering an organosilicon quaternary ammonium salt compound to at least a part of a surface of the substrate; and
adhering a cationic polymer to at least a part of the substrate surface.
